(19) United States
(12) Patent Application Publication
(10) Pub. No.: US 2025/0280789 A1
(43) Pub. Date: Sep. 11, 2025

(54) PET FEEDING DEVICE AND RECOGNITION SYSTEM FOR PET FEEDING DEVICE

(71) Applicant: Shenzhen Beibanqiu Network Technology Co., Ltd., Shenzhen (CN)

(72) Inventors: Xiangli ZHANG, Shenzhen (CN); Wen WAN, Shenzhen (CN)

(73) Assignee: Shenzhen Beibanqiu Network Technology Co., Ltd., Shenzhen (CN)

(21) Appl. No.: 19/218,501

(22) Filed: May 26, 2025

(30) Foreign Application Priority Data
Apr. 24, 2025 (CN) 202510522500.X

(51) Int. Cl. A01K 5/02; E05F 15/619; E05F 15/76

(52) U.S. Cl. CPC A01K 5/02; E05F 15/619; E05F 15/76

(57) ABSTRACT

The present invention discloses a pet feeding device and a recognition system for pet feeding device, comprising: a housing, a hatch door arranged on the housing, and a food tray arranged in the housing, wherein the food tray can prevent pets from spilling food outside the food tray during eating. The housing is provided with a driving mechanism and a hatch door linkage mechanism, wherein the hatch door linkage mechanism is drivingly connected to an output end of the driving mechanism and connected with the hatch door. The driving mechanism is used for driving the hatch door linkage mechanism to lead the hatch door to open and close. This solution not only controls the food intake of the pets, but also controls the feeding time of the pets.

### CROSS-REFERENCE TO RELATED APPLICATIONS

The application claims priority to Chinese patent application No. 202510522500.X, filed on Apr. 24, 2025, the entire contents of which are incorporated herein by reference.

### TECHNICAL FIELD

The present invention relates to the field of pet devices, and particularly relates to a pet feeding device and a recognition system for pet feeding device.

### BACKGROUND

With the improvements of living standards, an increasing number of people are willing to keep pets to relieve stress from daily life and work. Pets refer to animals which are kept by people for emotional purposes. As pet industry has now become an emerging and dynamic project, pet feeding has become particularly crucial. Therefore, designing a pet feeding device capable of automatically delivering food for pets to eat has significant economic and practical values.

Pet feeders in the existing technology generally control the pets' feeding time by extending food trays at regular time. Although this method can ensure that the pets eat food in fixed positions and help to keep households clean and tidy, the food may be randomly dug or scattered by the pets after the food trays are extended, thus the food intake and feeding time of the pets cannot be effectively controlled. Therefore, the above technical solution needs to be improved urgently.

### SUMMARY

To overcome the shortcomings of the existing technology, the present invention provides a pet feeding device and a recognition system for pet feeding device, which can more accurately control the food intake of the pets.

The present invention adopts the following technical solution to solve its technical problems.

A pet feeding device comprises a housing, a hatch door arranged on the housing, and a food tray arranged in the housing; wherein the housing is provided with a driving mechanism and a hatch door linkage mechanism. The hatch door linkage mechanism is drivingly connected to an output end of the driving mechanism and connected with the hatch door, and the driving mechanism is used for driving the hatch door linkage mechanism to lead the hatch door to open and close.

The pet feeding device as described above, the hatch door linkage mechanism includes a transmission gear set and a transmission rack.

The transmission rack is slidably arranged within the housing, the transmission gear set is drivingly connected to the output end of the driving mechanism and the transmission rack, and an end of the transmission rack is slidably connected to the hatch door.

The pet feeding device as described above, the transmission gear set includes a first transmission gear set and a second transmission gear set which are drivingly connected to the driving mechanism; the transmission rack includes a first transmission rack and a second transmission rack, and both the first transmission rack and the second transmission rack are slidably connected to the hatch door.

The pet feeding device as described above, sliding connection points of the first transmission rack and the second transmission rack with the hatch door are located on the same horizontal plane.

The pet feeding device as described above, a side of the transmission rack is fixed with a transmission inductor, and the transmission inductor communicates with the driving mechanism.

The transmission rack is provided with a first induction structure and a second induction structure for triggering the transmission inductor; when the first induction structure or the second induction structure triggers the transmission inductor, the driving mechanism stops driving the hatch door linkage mechanism to rotate or drives the hatch door linkage mechanism to reverse.

The pet feeding device as described above, the hatch door includes a first hatch door and a second hatch door hinged with the first hatch door, and the transmission rack is slidably connected to the second hatch door.

The pet feeding device as described above, the second hatch door is provided with a sliding groove, and the sliding groove is used for limiting a displacement distance of the transmission rack.

The pet feeding device as described above, a food control mechanism is also provided in the housing.

A recognition system for pet feeding device comprises a recognition device and the pet feeding device according to any one of claims 1-8. The pet feeding device is provided with a distance induction module, and the distance induction module communicates with the driving mechanism. The recognition device is used to be worn on a pet, when the recognition device enters a recognition range of the distance induction module, the distance induction module sends a driving signal to the driving mechanism so as to open or close the hatch door.

The recognition system for pet feeding device as described above, an induction range of the distance induction module is 0-1m.

The present invention has following beneficial effects.

1. In the pet feeding device of the present invention, the food tray is arranged in the housing, so as to prevent the pets from spilling food outsides of the food tray during feeding. Upon reaching a preset feeding time, the driving mechanism operates and drives the hatch door linkage mechanism to open the hatch door, so that the pets can put their heads into the housing to eat food. Conversely, the driving mechanism drives the hatch door linkage mechanism to close the hatch door. Therefore, this solution not only controls the food intake of the pets, but also controls the feeding time of the pets.

2. In the recognition system of the present invention, when the recognition device enters a recognition range of the distance induction module, the distance induction module sends a driving signal to the driving mechanism so as to open or close the hatch door, which has high degree of intelligence and can further assist in controlling the food intake and feeding time of the pets.

### BRIEF DESCRIPTION OF DRAWINGS

The present invention will be further explained in combination with the drawings and embodiments hereinafter.

FIG. 1 is an exploded view of a pet feeding device.

FIG. 2 is a top cross-sectional view of the pet feeding device.

FIG. 3 is another top cross-sectional view of the pet feeding device.

FIG. 4 is a side cross-sectional view of the pet feeding device.

FIG. 5 is another side cross-sectional view of the pet feeding device.

FIG. 6 is a schematic structural view of a hatch door linkage mechanism and a hatch door.

### DETAILED DESCRIPTION OF THE EMBODIMENTS

In order to fully understand the objectives, features and effects of the present invention, the concepts, specific structures and technical effects of the present invention will be clearly and completely described in combination with the embodiments and drawings hereafter. Apparently, the described embodiments are merely part of the embodiments of the present invention, but not all of the embodiments. Based on the embodiments of the present invention, all other embodiments obtained by those of ordinary skill in the art without exerting creative efforts shall fall within the protection scope of the present invention. In addition, all connections or connection relationships involved in the patent refer to direct connections between components, but rather indicate that, optimal connection structures may be formed by adding or reducing auxiliary connecting elements depending on specific the specific embodiments. The various technical features of the present invention may be combined interactively without conflicting with each other.

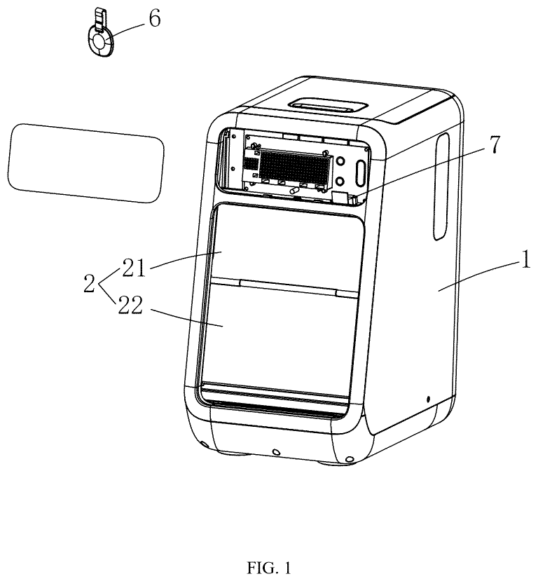

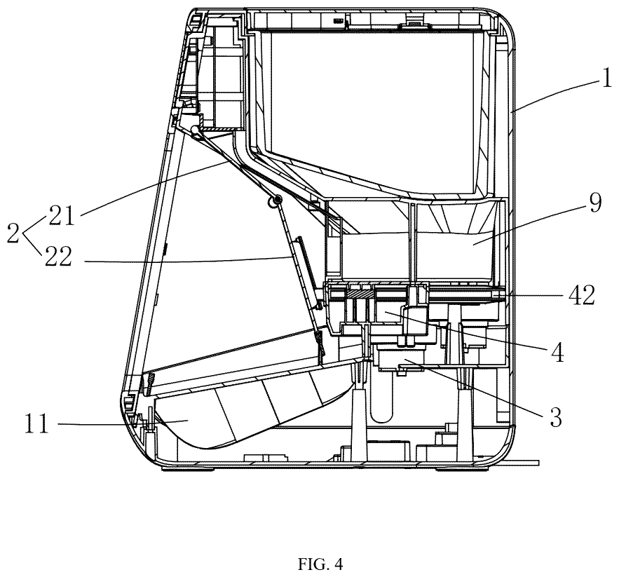

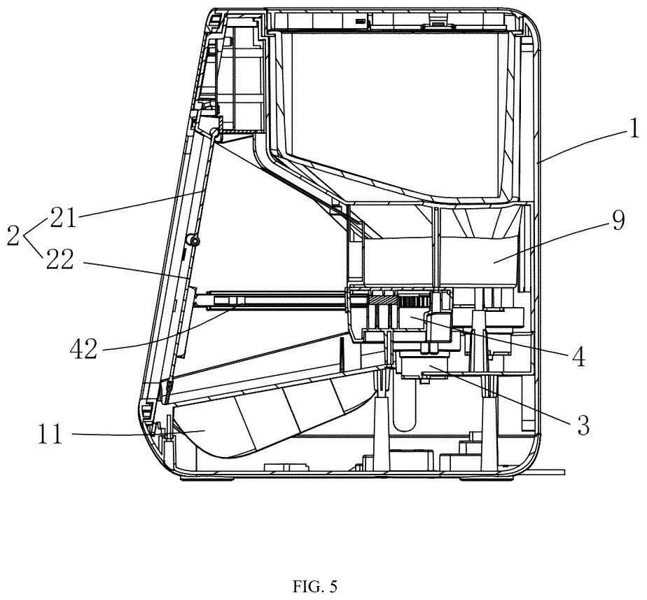

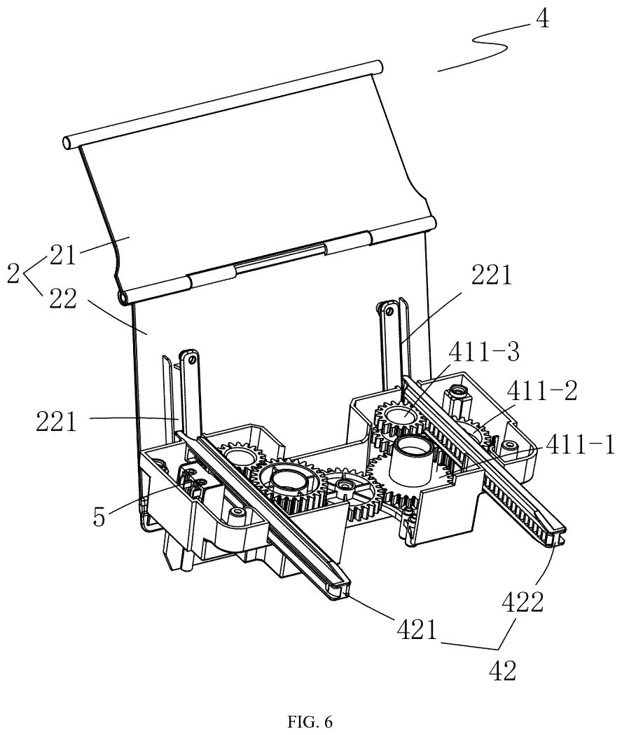

Refer to FIGS. 1 to 6, a pet feeding device comprises a housing 1, a hatch door 2 arranged on the housing, and a food tray 11 arranged in the housing 1. The housing 1 is provided with a driving mechanism 3 and a hatch door linkage mechanism 4, the hatch door linkage mechanism 4 is drivingly connected to an output end of the driving mechanism 3 and connected with the hatch door 2, and the driving mechanism is used for driving the hatch door linkage mechanism 4 to lead the hatch door 2 to open and close.

The food tray 11 is arranged in the housing 1 to prevent pets from spilling food outsides of the food tray during feeding. Through the cooperation of the driving mechanism 3 and the hatch door linkage mechanism 4, the hatch door 2 can be automatically opened and closed so as to provide food for the pets, which can effectively prevent the pets from entering the food tray 11 at any time and avoid food wastes caused by trampling, spilling, and other mishaps. Besides, the hatch door 2 can seal the food tray 11 when feeding is not required, so as to prevent food contamination and ensure the pets' health. Therefore, this solution not only controls the food intake of the pets, but also controls the feeding time of the pets, which helps the pets to develop good biological clocks and healthy dietary habits, thereby avoiding obesity or gastrointestinal problems caused by irregular diets.

Specifically, the driving mechanism 3 in this embodiment is a servo motor.

Specifically, the hatch door linkage mechanism 4 may be any one of a chain transmission mechanism, a belt transmission mechanism, or a screw transmission mechanism.

In one embodiment, the hatch door linkage mechanism 4 includes a transmission gear set 41 and a transmission rack 42.

The transmission rack 42 is slidably arranged in the housing 1, the transmission gear set 41 is drivingly connected to an output end of the driving mechanism 3 and the transmission rack 42, and an end of the transmission rack 42 is slidably connected to the hatch door 2.

Taking the driving mechanism 3 as the servo motor as an example, when the output end of the driving mechanism 3 rotates, the transmission rack 42 is driven to slide through the transmission gear set 41, thereby converting a rotation motion of the driving mechanism 3 into a linear motion of the transmission rack 42, thus to drive the transmission rack 42 to push or close the hatch door 2.

When the output end of the driving mechanism 3 stops rotating, since the transmission gear set 41 and the transmission rack 42 are meshed by teeth, the transmission rack 42 can be locked indirectly through the transmission gear set 41, so as to avoid displacement of the transmission rack 42 when the driving mechanism 3 is not working. This embodiment can accurately control the linear motion of the transmission rack 42, and avoid that the hatch door 2 is not fully closed, thus to weaken the effect of the device in quantitatively controlling the pet feeding.

Compared to using the belt transmission structure to drive the hatch door to open and close, transmission belts are prone to loosening and fatigue fractures after long term use. When the hatch door 2 has a large weight, the transmission belts are easier to slip than the racks. In terms of the stability of the opening and closing of the hatch door 2, the rotation amount of the driving mechanism 3 can be controlled through the cooperation of the transmission gear set 41 and the transmission rack 42, thereby controlling the opening and closing amount of hatch door 2. In contrast, by adjusting the gear ratio and the motor speed of the transmission gear set 41, the displacement of the transmission rack 42 can be accurately controlled, thus to accurately control the opening and closing degree of the hatch door 2. The effect of the belt transmission structure is not as good as that of the transmission gear set 41 and the transmission rack 42 applied in this embodiment.

Specifically, a transmission ratio of the transmission gear set 41 can be configured as fixed, thus to ensure that the opening and closing movements of the hatch door is stable and accurate.

In terms of later maintenance, the transmission gear set 41 and the transmission rack 42 have relatively simple structures, and the functions and connection methods of each component are clear at a glance, so that technicians or users can quickly understand the working principles of the device and accurately determine fault points during maintenance and repair. For example, when the hatch door 2 occurs abnormal opening and closing, the technicians or users can quickly check whether the gears are worn and whether the racks are jammed, thereby enhancing the maintenance efficiency.

Specifically, the number of the transmission rack 42 may be any one of the values from 1 to 10.

When the transmission rack 42 has fewer connection points with the hatch door 2, the hatch door 2 may slightly deflect when opening and closing, so that the hatch door 2 is not fully closed. To solve this problem, in one embodiment, the transmission gear set 41 includes a first transmission gear set 411 and a second transmission gear set 412, both of which are drivingly connected to the driving mechanism 3. The transmission rack 42 includes a first transmission rack 421 and a second transmission rack 422. Both the first transmission rack 421 and the second transmission rack 422 are slidingly connected to the hatch door 2.

In this embodiment, there are at least two indirectly connected connection points between the hatch door 2 and the driving mechanism 3, so as to further enhance the stability of the hatch door 2 during movement, balance the force on the hatch door 2, and reduce the risk of tilting or jamming during movement, which may lead to incomplete closing, thereby avoiding gaps between the hatch door and the housing 1, and preventing the pets from getting food through the gaps.

Specifically, the first transmission gear set 411 has at least one more gear than the second transmission gear set 412, ensuring that the first transmission rack 421 and the second transmission rack 422 can move in the same direction

For example, the second transmission gear set 412 includes a first gear 412-1 and a second gear 412-2, wherein the first gear 412-1 is drivingly connected to the output end of the driving mechanism 3, and the second gear 412-2 is drivingly connected to the first transmission rack 421. The first transmission gear set 411 includes a third gear 411-1, a fourth gear 411-2 and a fifth gear 411-3, wherein third gear 411-1 is drivingly connected to the output end of the driving mechanism 3, the fourth gear 411-2 is drivingly connected to the fifth gear 411-3, and the fifth gear 411-3 is drivingly connected to the second transmission rack 422. When the output end of the driving mechanism 3 rotates, the first gear 412-1 and the third gear 411-1 are driven to rotate synchronously, thus to drive the second gear 412-2 and the fifth gear 411-3 to rotate, so that the first transmission rack 421 and the second transmission rack 422 move in the same direction.

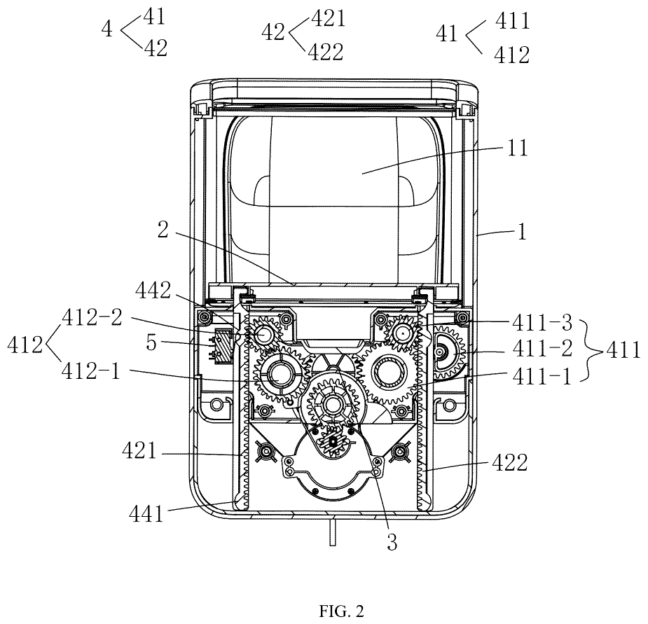

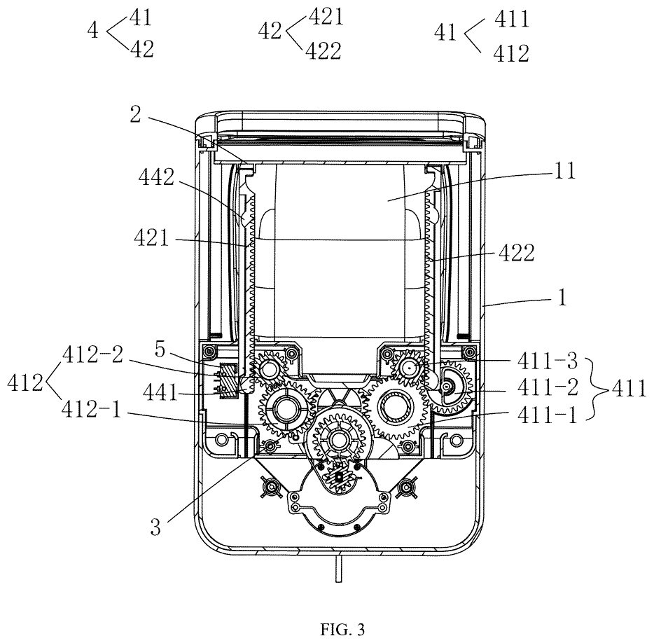

Refer to FIGS. 2 and 3, in one embodiment, sliding connection points of the first transmission rack 421 and the second transmission rack 422 with the hatch door are located on the same horizontal plane.

In terms of the design cost of the transmission gear set 41, the first transmission gear set 411 and the second transmission gear set 412 can be designed as a coplanar structure, without the need to additionally design transition gears to compensate for height differences or complex driving mechanisms, thereby reducing component types and processing complexity while improving interchangeability between gears and racks.

In terms of appearance, the first transmission gear set 411 and the second transmission gear set 412 can be designed as a coplanar structure, which can reduce the volume of the pet feeding device, thereby further reducing the space occupied by the pet feeding device.

For effects of driving the hatch door 2 to open and close, the sliding connection points being coplanar can further ensure smooth movement of hatch door 2, avoiding poor opening and closing caused by the height difference between the first transmission rack 421 and the second transmission rack 422, and further optimizing the sealing effect when the hatch door 2 moves horizontally.

Specifically, in this embodiment, in the first transmission gear set 411 and the second transmission gear set 412, the gears directly engaged with the driving mechanism 3 (such as the first gear 412-1 and the fourth gear 411-1) and the gears directly engaged with the first transmission rack 421 and the second transmission rack 422 (such as the third gear 412-3 and the seventh gear 411-4) share the same transmission ratio, thereby ensuring that the first transmission rack 421 and the second transmission rack 422 move synchronously in the same direction at the same speed, and further optimizing the sealing effect when the hatch door 2 moves horizontally.

Refer to FIGS. 2 and 3, in one embodiment, a side of the transmission rack 42 is fixed with a transmission inductor 5, and the transmission inductor 5 communicates with the driving mechanism 3.

The transmission rack 42 is provided with a first induction structure 441 and a second induction structure 442 for triggering the transmission inductor 5; when either the first induction structure 441 or the second induction structure 442 triggers the transmission inductor 5, the driving mechanism 3 stops driving the hatch door linkage mechanism 4 to rotate or drives the hatch door linkage mechanism 4 to reverse.

For example, in the process of closing the hatch door 2, when the transmission rack 42 moves, the first induction structure 441 and the second induction structure 442 move synchronously. When the transmission rack 42 drives the hatch door 2 to slide into a closed state, the first induction structure 441 is in an induction range of the transmission inductor 5. At this time, the driving mechanism 3 stops driving the hatch door linkage mechanism 4 to rotate, and the transmission rack 42 stops moving, so as to achieve the effect of closing the hatch door 2. When the hatch door 2 needs to be opened, the driving mechanism 3 drives the hatch door linkage mechanism 4 to reverse, and the transmission rack 42 is reset. The first induction structure 441 moves out of the induction range of the transmission inductor 5, and the transmission rack 42 continues to move, the transmission rack 42 drives the hatch door 2 to slide into an open state, and the second induction structure 442 is in the induction range of the transmission inductor 5. At this time, the driving mechanism 3 stops driving the hatch door linkage mechanism 4 to rotate, the transmission rack 42 stops moving, the hatch door 2 opens, and the pets can put their heads into the food tray to eat food.

Specifically, both the first sensing structure 441 and the second sensing structure 442 are protrusions arranged on the transmission rack 42. The transmission inductor 5 is a press-type inductor, when the first induction structure 441 and the second induction structure 442 move to a position where the transmission inductor 5 can be pressed, the driving mechanism 3 stops driving the hatch door linkage mechanism 4 to rotate or drives the hatch door linkage mechanism 4 to reverse.

The first induction structure 441 and the second induction structure 442 are ingeniously arranged on the transmission rack 42, and are closely cooperated with the transmission inductor 5, so as to achieve automated control of the opening and closing of the hatch door 2, which significantly improves automation level of the device and brings an excellent use experience.

When the driving mechanism 3 starts, the generated power is accurately transmitted to the transmission rack 42 through the transmission gear set 41, driving the transmission rack 42 to slide smoothly within the housing 1. In this process, the first induction structure 441 and the second induction structure 442 arranged on the side of the transmission rack 42 will move synchronously with the transmission rack 42. When the hatch door 2 reaches a preset opening position, the second induction structure 442 triggers the transmission inductor 5, and the transmission inductor 5 sends a signal to the driving mechanism 3 immediately. Upon receiving the signal, the driving mechanism 3 accurately controls itself to stop working, ensuring that the hatch door 2 remains stably open, which is convenient for the pets to eat food. Conversely, when the hatch door 2 needs to be closed, the driving mechanism 3 reverses, driving the transmission rack 42 to move in an opposite direction. When the first induction structure 441 triggers the transmission inductor 5, the driving mechanism 3 will stop in time, and the hatch door 2 will be closed accurately.

Compared to the solutions that the first induction structure 441 and the second induction structure 442 are arranged on chain transmission or belt transmission structures, the latter has obvious drawbacks in practical operation. Chains or belts in the chain transmission or belt transmission structures are typically made of flexible materials, when they are in contact with press-type inductors, they are prone to deform, resulting in dispersing compression strength and significantly reducing compression effects, so that the transmission inductor 5 may fail to accurately identify whether the hatch door 2 has been opened and closed in place. In such case, the driving mechanism 3 will continue working even after the hatch door 2 has reached the preset opening and closing positions, and the hatch door linkage 4 will still drive the hatch door 2 to continue moving; this will not only lead to collisions and interference between hatch door 2 and other components, causing serious damages to the structure of the hatch door 2 and affecting the sealing and stability of the device, but also will lead to increased wear on the transmission components, greatly shortening the service life of the device and increasing maintenance costs.

In this embodiment, the first induction structure 441 and the second induction structure 442 are applied to the transmission rack 42. The drive rack 42 is typically made of high-strength metal material, which has excellent rigidity. Compared to the chains or belts, it can always maintain a stable shape during movement and will not deform due to contact with the transmission inductor 5. This ensures that the first induction structure 441 and the second induction structure 442 can generate clear and accurate signals when triggering the transmission inductor 5, so that the driving mechanism 3 can respond in time, so as to ensure that the hatch door 2 is moved precisely into position each time, avoiding damages to the device due to excessive opening or closing, thereby further enhancing the practicality and reliability of the entire pet feeding device.

The transmission inductor 5 can precisely control the start, stop, and direction reversal of the driving mechanism 3, so as to avoid unnecessary collisions and impacts during the opening and closing of the hatch door 2. Compared to traditional manual control method or automatic control method lacking precise induction, the wear between components such as the transmission rack 42, the transmission gear set 41 and the hatch door 2 can be reduced, thus to prolong the service life of the whole device.

When the feeding device occurs problems of abnormal opening and closing of the hatch door, the fault points can be quickly identified by checking working status of the transmission inductor 5 and the induction structures. For example, if the first induction structure 441 fails to trigger the transmission inductor 5, there may be damages to the induction structures or failures to the transmission inductor 5, and maintenance personnel can targetedly perform repairs or replacements, which improves maintenance efficiency and reduces downtime of the device.

In this device, the whole process of opening and closing the hatch door 2 does not require manual intervention, which effectively avoids that the hatch door is not fully opened and closed due to the negligence of manual operation, thereby greatly improving the convenience and accuracy of the pet feeding. For example, during pet owner's travel, the feeding device can still automatically and accurately complete the opening and closing operation of the hatch door according to the preset procedure, ensuring that the pets are fed on time.

In one embodiment, the hatch door 2 includes a first hatch door 21 and a second hatch door 22 hinged with the first hatch door 21. The first hatch door 21 is hinged on the housing 1, and the transmission rack 42 is slidingly connected to the second hatch door 22.

The hatch door 2 adopts a folding design, which is composed of a hatch door 1 and a second hatch door 22 connected by a special hinged structure. This folding hatch door design greatly optimizes space utilization efficiency of the device and brings numerous practical values to users.

When the hatch door 2 needs to be opened, the driving mechanism 3 starts and drives the hatch door linkage mechanism 4 to start operation, and the hatch door linkage mechanism 4 pulls the second hatch door 22 to move towards a direction close to the driving mechanism 3. During this process, the first hatch door 21 remains relatively fixed with its hinge point with the housing 1 as an axis, while the second hatch door 22 rotates around the hinge point of the first hatch door 21. As the second hatch door 22 moves, a certain angle is gradually formed between the first hatch door 21 and the second hatch door 22, so that the hatch door 2 is in a folded and opened state as a whole. Compared to traditional sliding or double-leaf hatch doors, the space occupied by the hatch door within the housing 1 is greatly reduced.

For example, in some pet living areas with limited space, traditional hatch doors may cause inconvenience because they take up too much space when the hatch doors are opened, whereas the folding hatch doors can easily solve this problem, ensuring that the pet feeding devices can flexibly adapt to various environments.

When the pet finishes eating food and the hatch door 2 needs to be closed, the drive mechanism 3 reverses and drives the hatch door linkage mechanism 4 to move in an opposite direction. The hatch door linkage mechanism 4 pushes the second hatch door 22 to move in a direction away from the driving mechanism 3, the second hatch door 22 rotates around its hinge point with the first hatch door 21, so that an angle between the first hatch door 21 and the second hatch door 22 gradually increases until the first hatch door 21 and the second hatch door 22 are arranged side by side, and the hatch door 2 is fully closed at this time, effectively preventing dust and impurities from polluting the food, thereby ensuring the hygiene and safety of the food in the food tray 11.

Specifically, an articulated shaft of the first hatch door 21 and the housing 1 is parallel to a horizontal plane, and an articulated shaft of the second hatch door 22 is parallel to the horizontal plane.

The food tray 11 is positioned below the hatch door 2, the hatch door 2 sweeps over the top of the food tray 11 when opening or closing, that is, the second hatch door 22 is driven by the hatch door linkage mechanism 4 to sweep over the top of the food tray, so as to open or close the pet feeding device, allowing the pets to eat the food inside the food tray 11.

Specifically, the food tray 11 is made of hardware material, compared to the food trays made of plastic material, the hardware material is easier to clean.

Specifically, to prevent the pets from hitting their heads while eating food, an anti-collision rubber strip is arranged on a side of the second hatch door 22 near the food tray 11.

In one embodiment, the second hatch door 22 is provided with a sliding groove 221 used for limiting a displacement distance of the transmission rack 42. Moreover, if the transmission rack 42 moves excessively fast, the second hatch door 22 may detach from the transmission rack 42 under action of inertia. Therefore, on the one hand, the sliding groove 221 can limit the displacement distance of the second hatch door 22; on the other hand, it can prevent the second hatch door 22 from disengaging from the transmission rack 42, thus to further improve the stability of the hatch door 2 during movement.

In one embodiment, a food control mechanism 9 is also provided within the housing 1. The food control mechanism 9 is used to control the amount of the food flowing into the food tray 11, so as to realize timed and quantified control of feeding portions.

A study found that, for a household with multiple pets, different pets may have different feeding demands. However, the existing pet feeders can only provide quantitative feeding for a single pet, which is not applicable to the household with multiple pets. To achieve quantitative feeding for each pet, multiple pet feeders would need to be purchased, resulting in high costs. Therefore, in order to solve the above technical problems and improve versatility of the device, this embodiment provides a recognition system for the pet feeding device, including a recognition device 6 and the pet feeding device described in any of the above embodiments. The pet feeding device is provided with a distance induction module 7, and the distance induction module 7 communicates with the driving mechanism 3. The recognition device 6 is worn on the pet, when the recognition device 6 enters a recognition range of the distance induction module 7, the distance induction module 7 sends a driving signal to the driving mechanism 3 to open and close the hatch door 2.

Taking a household with two cats as an example, wherein one cat called as cat A is overweight and needs to lose weight, and the other cat called as cat B keeps a normal weight and can eat normally. The recognition device 6 is worn on the cat B, when the cat A wants to eat cat food and enters the recognition range of the distance induction module 7, the hatch door 2 keeps closed at this time, so that the food intake of the cat A can be controlled, thus to help the cat A to lose weight.

Alternatively, wherein one cat called as cat C is sick and needs prescription diets for treatment, while the other cat called as cat D can eat normally. The pet feeding device is equipped with the prescription diets for treating the cat C, and the recognition device 6 is worn on the cat C. When the cat C wants to eat cat food and enters the recognition range of the distance induction module 7, the door 2 opens, thereby preventing the cat D from eating the prescription diets for the cat C, and ensuring treatment effects.

In this embodiment, the recognition device 6 and the distance induction module 7 are cooperated with each other, so that the pet feeding device can be used to feed multiple pets at the same time, which is suitable for the household with multiple pets. It not only lowers acquisition cost of the pet feeding device, but also reduces the occupying area of the pet feeding device.

In one embodiment, an induction range of the distance induction module 7 is 0-1m. If the induction range of the distance induction module 7 is configured within 0-0.8m, when the cat B or cat C wearing the recognition device 6 is 0-0.8m away from the pet feeding device, the hatch door 2 opens, allowing them eating food.

For the households with multiple pets, this system is cooperated with the pet feeding device, so that the pets can be fed with fixed time and quantitative food, which has high degree of intelligence and further improves user experience.

The above are specific descriptions of the preferred embodiments of the present invention, but the present invention is not limited to the embodiments. Those skilled in the art may make various equivalent modifications or substitutions without departing from the spirits of the present invention, and all such equivalent modifications or substitutions shall fall within the scope defined by the claims of the present invention.

What is claimed is:

1. A pet feeding device, comprising: a housing, a hatch door arranged on the housing, and a food tray arranged in the housing; wherein a driving mechanism and a hatch door linkage mechanism are configured in the housing, the hatch door linkage mechanism 4 is drivingly connected to an output end of the driving mechanism and connected with the hatch door, and the driving mechanism is used for driving the hatch door linkage mechanism to lead the hatch door to open and close.

2. The pet feeding device according to claim 1, wherein the hatch door linkage mechanism includes a transmission gear set and a transmission rack,
the transmission rack is slidably arranged within the housing, the transmission gear set is drivingly connected to the output end of the driving mechanism and the transmission rack, an end of the transmission rack is slidably connected to the hatch door.

3. The pet feeding device according to claim 2, wherein the transmission gear set includes a first transmission gear set and a second transmission gear set which are drivingly connected to the driving mechanism;
the transmission rack includes a first transmission rack and a second transmission rack, and both the first transmission rack and the second transmission rack are slidably connected to the hatch door.

4. The pet feeding device according to claim 2, the first transmission gear set has at least one more gear than the second transmission gear set.

5. The pet feeding device according to claim 4, in the first transmission gear set and the second transmission gear set, the gears directly engaged with the driving mechanism, and the gears directly engaged with the first transmission rack and the second transmission rack share the same transmission ratio.

6. The pet feeding device according to claim 3, wherein sliding connection points of the first transmission rack and the second transmission rack with the hatch door are located on the same horizontal plane.

7. The pet feeding device according to claim 3, wherein a side of the transmission rack is fixed with a transmission inductor, and the transmission inductor communicates with the driving mechanism;
the transmission rack is provided with a first induction structure and a second induction structure for triggering the transmission inductor; when the first induction structure or the second induction structure triggers the transmission inductor, the driving mechanism stops driving the hatch door linkage mechanism to rotate or drives the hatch door linkage mechanism to reverse.

8. The pet feeding device according to claim 7, both the first sensing structure and the second sensing structure are protrusions arranged on the transmission rack, the transmission inductor is a press-type inductor, when the first induction structure and the second induction structure move to a position where the transmission inductor is pressed, the driving mechanism stops driving the hatch door linkage mechanism to rotate or drives the hatch door linkage mechanism to reverse.

9. The pet feeding device according to claim 2, wherein the hatch door includes a first hatch door and a second hatch door hinged with the first hatch door, and the transmission rack is slidably connected to the second hatch door.

10. The pet feeding device according to claim 9, the second hatch door is foldable relative to the first hatch door.

11. The pet feeding device according to claim 10, an articulated shaft between the first hatch door and the housing is parallel to a horizontal plane, and another articulated shaft between the second hatch door is parallel to the horizontal plane.

12. The pet feeding device according to claim 9, wherein the second hatch door is provided with a sliding groove, and the sliding groove is used for limiting a displacement distance of the transmission rack.

13. The pet feeding device according to claim 1, wherein a food control mechanism is also provided in the housing.

14. A recognition system for pet feeding device, comprising at least a recognition device and the pet feeding device according to claim 1, wherein the pet feeding device is provided with a distance induction module, and the distance induction module communicates with the driving mechanism;
the recognition device is used to be worn on a pet, when the recognition device enters a recognition range of the distance induction module, the distance induction module sends a driving signal to the driving mechanism so as to open or close the hatch door.

15. The recognition system for pet feeding device according to claim 14, wherein an induction range of the distance induction module is 0-1m.
